(19) United States
(12) Patent Application Publication
(10) Pub. No.: US 2025/0130720 A1
(43) Pub. Date: Apr. 24, 2025

(54) WEAR LEVELING OPERATIONS IN MEMORY DEVICES

(71) Applicant: MICRON TECHNOLOGY, INC., Boise, ID (US)

(72) Inventors: Marco Sforzin, Cernusco sul Naviglio (IT); Emanuele Confalonieri, Segrate (IT)

(21) Appl. No.: 18/903,468

(22) Filed: Oct. 1, 2024

Related U.S. Application Data
(60) Provisional application No. 63/545,434, filed on Oct. 24, 2023.

(51) Int. Cl. G06F 3/06

(52) U.S. Cl. CPC G06F 3/0616; G06F 3/065; G06F 3/0679

(57) ABSTRACT

A system includes a memory device; and a processing device coupled to the memory device, the processing device to perform operations including: identifying at least one unusable management unit (UMU) in a plurality of management units that are designated for wear leveling; storing, in a data structure, a physical address and a logical address of the identified at least one UMU; excluding, from a physical address space for wear leveling, the physical address of the identified at least one UMU; and performing a wear leveling operation using the physical address space, wherein the wear leveling operation moves data of a management unit to a neighboring management unit in a circular manner.

### RELATED APPLICATIONS

This application claims the benefit of U.S. Provisional Application No. 63/545,434, filed Oct. 24, 2023, which is incorporated herein by reference.

### TECHNICAL FIELD

Embodiments of the disclosure relate generally to memory sub-systems, and more specifically, relate to wear leveling operations in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIGS. 2A-2B are flow diagrams of example methods to perform start-gap wear leveling with unusable management units in a memory device, in accordance with some embodiments of the present disclosure.

FIGS. 3A-3E illustrate examples of algorithm and architecture of the modified start-gap wear leveling, in accordance with some embodiments of the present disclosure.

FIGS. 4A-4B illustrate examples of performing the modified start-gap wear leveling, in accordance with some embodiments of the present disclosure.

FIG. 5 is a block diagram of an example computer system in which embodiments of the present disclosure may operate.

### DETAILED DESCRIPTION

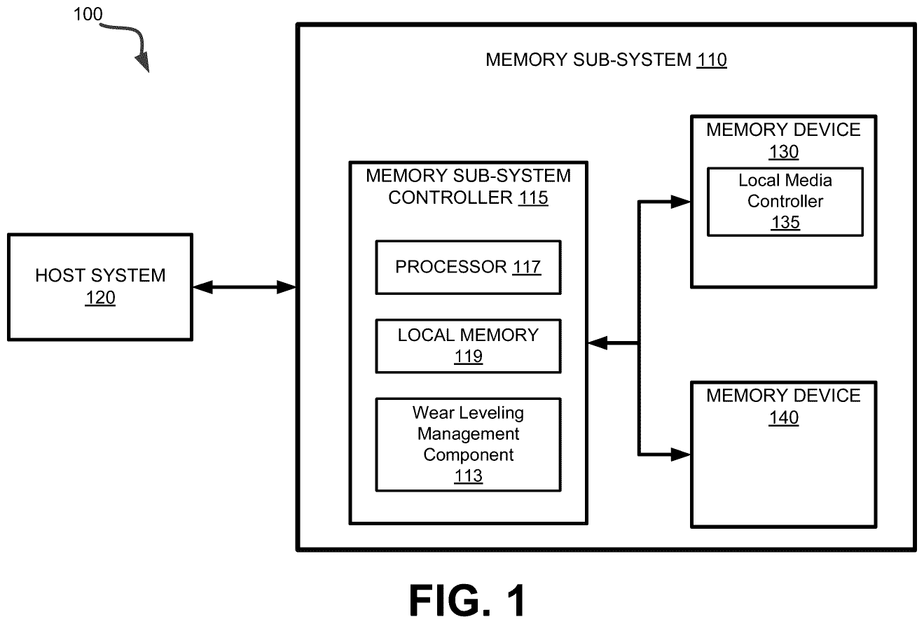

Aspects of the present disclosure are directed to start-gap wear leveling with unusable management units in a memory device. A memory sub-system can be a storage device, a memory module, or a combination of a storage device and memory module. Examples of storage devices and memory modules are described below in conjunction with FIG. 1. An example of a memory sub-system is a storage device that is coupled to a central processing unit (CPU) via a peripheral interconnect (e.g., an input/output bus, a storage area network). Examples of storage devices include a solid-state drive (SSD), a flash drive, a universal serial bus (USB) flash drive, and a hard disk drive (HDD). Another example of a memory sub-system is a memory module that is coupled to the CPU via a memory bus. Examples of memory modules include a dual in-line memory module (DIMM), a small outline DIMM (SO-DIMM), a non-volatile dual in-line memory module (NVDIMM), etc. In some embodiments, the memory sub-system can be a hybrid memory/storage sub-system. In general, a host system can utilize a memory sub-system that includes one or more memory components. The host system can provide data to be stored at the memory sub-system and can request data to be retrieved from the memory sub-system.

A memory sub-system can include high density non-volatile memory devices where retention of data is desired when no power is supplied to the memory device. One example of a non-volatile memory device is a NAND memory device, such as 3D flash NAND memory, which offers storage in the form of compact, high density configurations. Other examples of non-volatile memory devices are described below in conjunction with FIG. 1. A non-volatile memory device is a package of one or more dies. Each die can include one or more planes. For some types of non-volatile memory devices (e.g., NAND memory devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in an array of columns and rows. A memory device can further include conductive lines connected to respective ones of the memory cells, referred to as wordlines and bitlines. A wordline can refer to one or more rows of memory cells of the memory device and a bitline can refer to one or more columns of memory cells. The intersection of a bitline and a wordline constitutes the address of the memory cell. A block refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

Memory devices at a memory sub-system can have particular properties that provide challenges in the operation of the memory sub-system. Some memory devices, such as non-volatile memory devices, can have limited endurance. For example, some memory devices can be written, read, or erased a finite number of times before the memory devices begin to physically degrade or wear and eventually fail.

A memory sub-system controller can perform media management operations to mitigate the effect of physical wear on the memory devices and lengthen the overall lifetime of the memory sub-system. For example, the memory sub-system controller can perform a wear leveling operation to distribute the physical wear across management units of a memory device. A management unit refers to a particular amount of memory, such as a page or a block, of a memory device. To perform a wear leveling operation, the memory sub-system controller can identify a management unit at a memory device that is subject to a significant amount of physical wear and can move data stored at the management unit to another management unit subject to a smaller amount of physical wear. In some instances, a management unit can be subject to a significant amount of physical wear if a large number of memory access operations, such as write operations (i.e., program operations) or read operations, are performed at the management unit. As such, in some implementations, the memory sub-system controller can identify management units that are subject to large amounts of physical wear based, for example, on write counts for each management unit. A write count refers to a number of times that the memory sub-system controller performs a write operation at a particular management unit over the lifetime of the management unit. The data from a management unit having a high write count can be swapped with the data of a management unit having low write count in an attempt to evenly distribute the wear across the management units of the memory component.

In some implementations, a memory sub-system controller can use large tables to track write counts and to relocate data to any other location in memory in an unconstrained fashion. The large tables and undirected relocation may require large storage, thus resulting in latency overhead, and increasing power consumption. These drawbacks can be overcome by implementing start-gap wear leveling, which uses a mapping between logical addresses and physical addresses in a limited address space, thus avoiding tracking large amounts of write counts. The controller may then perform wear leveling operations by periodically moving each management unit to its neighboring location, regardless of the write traffic to the management unit. Start-gap wear leveling operations employ two registers: a start register and a gap register, and an extra memory management unit to facilitate data movement. The controller can utilize the gap register to keep track of the number of management units that have been moved. When all the management units in a pool of management units designated for wear leveling operations have been moved, the controller can increment the start register, thus keeping track of the number of times all management units have been moved. The mapping of management units from logical address to physical address is done by operations of gap and start registers with the logical address, as explained below.

Specifically, a memory system designates multiple management units in a pool of management units for wear leveling operations, and each management unit corresponds to a physical address (e.g., 16 management units corresponding to physical address 0-15). To implement the start-gap wear leveling, an extra management unit is added at a location adjacent to the multiple management units (e.g., a location corresponding to physical address 16). The total management units including the extra management unit (e.g., 16 management units plus one extra management unit) can form a circular pool. The extra management unit is a memory location that contains no useful data. The start register and the gap register are initialized such that the start register would initially point to a location corresponding to a physical address (e.g., physical address 0), and the gap register, which always points to the location of the extra management unit, would initially point to a location corresponding to a physical address (e.g., physical address 16). Upon performing a predefined number of memory write operations, the content of location referenced by the gap register decremented by one (e.g., a location corresponding to physical address 15) is copied to the location of the extra management unit (e.g., a location corresponding to physical address 16). That is, the content is moved to a neighboring location. The values stored by the gap register are then decremented, such that it would reference a neighboring location, which, after moving the content, would be the location identified by a physical address that immediately precedes the physical address in the address range (e.g., physical address 15). After the number of movements of the gap register reaches to the number of management units in the pool of management units for wear leveling operations (e.g., 16 movements), the gap register is wrapped around the address range (e.g., pointing to physical address 0). For the next data movement, the gap register is reset to the initial address of the range (e.g., pointing to physical address 16), and because the contents of all (e.g., 16) management units in the pool have been moved once, the start register is incremented by one. As such, every movement of the gap register provides a remapping of the content (specific to a logical address) to its neighboring location (corresponding to a physical address).

However, such a wear leveling scheme may not exclude the management units that have been considered unusable for storing data, but are still used for wear leveling. Because of the circular usage of the management units for moving data, data would have been stored using the unusable management unit. Eventually, data stored at management units becomes unreliable. The unusable management unit used in the start-gap wear leveling can reduce the overall efficiency and increase the overall latency of the memory sub-system.

Aspects of the present disclosure address the above and other deficiencies by enabling a controller to exclude unusable management units from the address space used in the start-gap wear leveling. A management unit refers to a set of memory cells, such as a data block or a page that can be managed for wear leveling. An unusable management unit (UMU) refers to a management unit that is found to be unsuitable for data storage and thus should no longer be used for wear leveling. The address space used in the start-gap wear leveling (referred to as wear leveling pool) refers to addresses of management units used in the start-gap wear leveling, and can include the logical address space, including the logical addresses of the management units used in the start-gap wear leveling, and the physical address space, including the physical addresses of the management units used in the start-gap wear leveling.

The controller can manage dynamic reduction of the wear leveling pool. The memory sub-system controller can identify one or more UMUs during the wear leveling operation., For example, upon performing a predefined number of memory write operations, the memory sub-system controller moves data for wear leveling, which can be referred to as a step of the wear leveling operation, and the memory sub-system controller can identify one or more UMUs before, during, or after a step of the wear leveling operation. The memory sub-system controller can keep a record on all identified UMUs so that the host system can access the record in order to recognize the UMUs. For example, the memory sub-system controller can store the physical addresses and the logical addresses of the UMUs in a data structure (e.g., logical to physical (L2P) table) including multiple records, such that each record maps a physical address to a logical address of the UMU. The memory sub-system controller can remove the locations corresponding to the identified UMUs from the wear leveling pool, i.e., excluding the address of the UMU from the address space used in the start-gap wear leveling.

With the dynamically reduced wear leveling pool, the memory sub-system controller can perform the start-gap wear leveling using the modified address space and modified registers. In one example, the memory sub-system controller designates a set of management units in the wear leveling pool, and each management unit corresponds to a physical address (e.g., management units in the number of N each corresponding to physical address 0 to N−1, respectively). To implement the start-gap wear leveling, an extra management unit containing no useful data is added at a location adjacent to the set of management units (e.g., a location corresponding to physical address N). During the wear leveling operation (e.g., at the time upon performing a predefined number of memory write operations), the memory sub-system controller identifies one or more (e.g., in the number of M) UMUs and removes, from the wear leveling pool, the identified UMUs. The size of the reduced wear leveling pool becomes the number of management unit subtracted by the number of the identified UMUs (e.g., N−M), and the total management units including the extra management unit (e.g., N+1−M management units) can form a circular pool. The memory sub-system controller introduces a first function, which refers to a function that translates an item from the original address space to a reduced address space. The memory sub-system controller uses the first function to translate the logical addresses in the address space (e.g., N management units) to the modified logical addresses in the reduced address space (e.g., N−M management units). The memory sub-system controller also uses the first function to translate the values of the start register and the gap register to a modified start register value and modified gap register value, respectively.

Upon performing a predefined number of memory write operations, the memory sub-system controller identifies a neighboring location (e.g., a nearest neighboring location along the moving direction of the gap register) that does not correspond to a UMU, the memory sub-system controller copies the content of the identified neighboring location to the location of the extra management unit. Specifically, the memory sub-system controller determines whether the location referenced by the modified gap register decremented by one corresponds to a UMU. Responsive to determining that the location referenced by the modified gap register decremented by one does not correspond to a UMU, the memory sub-system controller copies the content of location referenced by the modified gap register decremented by one to the location of the extra management unit, and the modified gap register value is decremented by one, i.e., pointing to a location moved by one. Conversely, responsive to determining that the location referenced by the modified gap register decremented by one corresponds to a UMU, and assuming that the location referenced by the modified gap register decremented by two does not correspond to a UMU, the memory sub-system controller then copies the content of location referenced by the modified gap register decremented by two to the location of the extra management unit, and the modified gap register is decremented by two, i.e., pointing to a location moved by two.

After the number of movements of the modified gap register reaches the number of management units in the reduced wearing level pool (e.g., N−M management units), the modified gap register is wrapped around the address range (e.g., pointing to a location corresponding to the first location in the circular pool). For the next data movement, the modified gap register is reset to the initial address of the range (e.g., pointing to a location corresponding to the last location in the circular pool), and because the contents of management units in the reduced wearing level pool (e.g., N−M management units) have been moved once, the modified start register is incremented by one. As such, every movement of the modified gap register provides a remapping of the content (specific to a logical address) to its non-UMU neighboring location (corresponding to a physical address).

In the above example, if the memory sub-system controller determines that the location referenced by the modified gap register decremented by two corresponds to a UMU, the memory sub-system controller will keep finding a nearest neighboring location that does not correspond to a UMU, for example, the location referenced by the modified gap register decremented by X. Then the controller copies the content of the location referenced by the modified gap register decremented by X to the location of the extra management unit, and the modified gap register is decremented by X, i.e., pointing to a location moved by X.

The memory sub-system controller can then introduce a second function, which refers to a function that translates an item from the reduced address space to the original address space The memory sub-system controller uses the second function to translate the modified physical addresses in the reduced address space (e.g., N−M management units) to the logical addresses in the original address space (e.g., N management units). As such, the memory sub-system controller performs a modified start-gap wear leveling with the UMUs excluded from the wear leveling pool.

Advantages of the present disclosure include, but are not limited to, an increase in an overall lifetime of a memory sub-system by performing wear leveling management operation on the memory sub-system. By excluding the UMUs from address space used in the start-gap wear leveling, the memory sub-system controller improves the reliability of data stored after performing wear leveling. As a result, the number of unnecessary wear leveling for management units at a memory device decreases, which increases the amount of system resources available to other processes. The increase in available system resources results in an increase in overall sub-system efficiency and a decrease in overall sub-system latency. Aspects of the present disclosure can be applied to emerging memory devices, not only the traditional memory devices.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes wear leveling management component 113 that manages the performance of wear leveling operations for memory devices 130, 140 during operation of memory sub-system 110. The wear leveling management component 113 can facilitate performing a modified start-gap wear leveling operation at a management unit (e.g., a block, a page, etc.) at memory device 130, 140. In some embodiments, the memory sub-system controller 115 includes at least a portion of the wear leveling management component 113. In some embodiments, the wear leveling management component 113 is part of the host system 110, an application, or an operating system. In other embodiments, local media controller 135 includes at least a portion of wear leveling management component 113 and is configured to perform the functionality described herein. Further details with regards to the operations of the wear leveling management component 113 are described below.

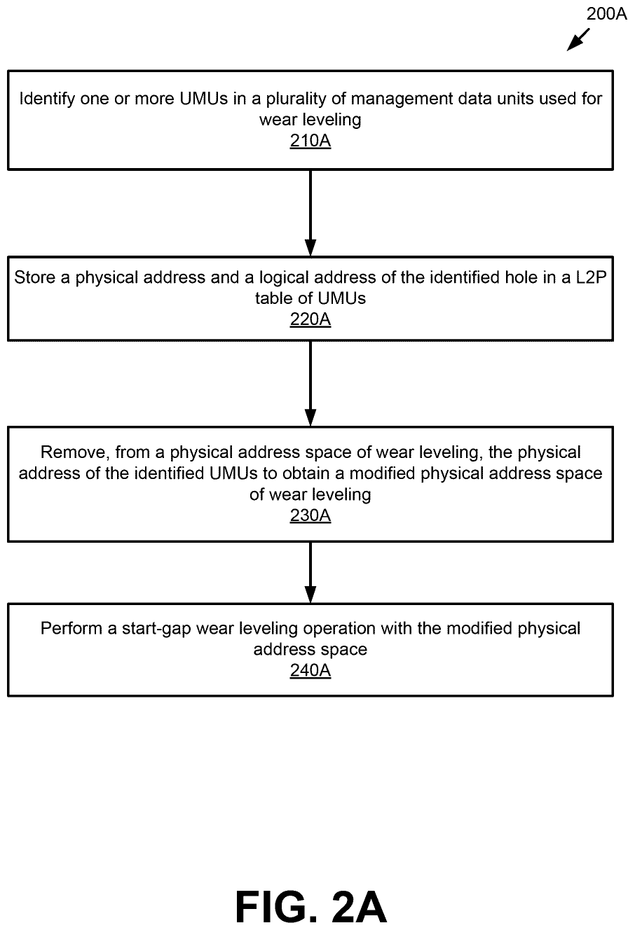

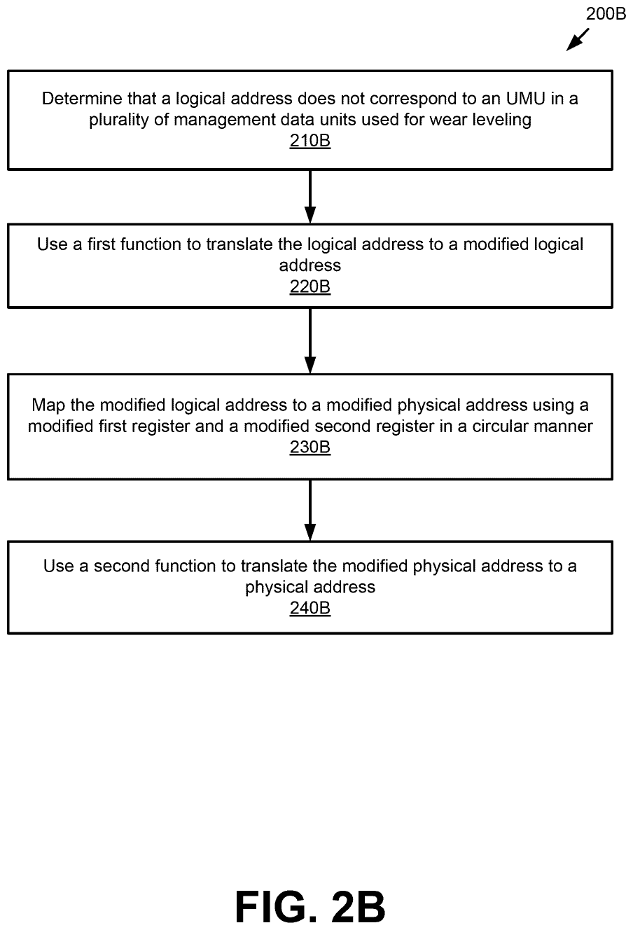

FIG. 2A is a flow diagram of an example method 200A to perform a start-gap wear leveling operation with UMUs in the memory device, in accordance with some embodiments of the present disclosure. The method 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200A is performed by the wear leveling management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210A, the processing logic identifies one or more UMUs in a plurality of management units designated for wear leveling. In some implementations, the processing logic may identify one or more UMUs by determining that an endurance metric (e.g., error rate, program/erase cycle) of one or more management units satisfy a threshold criterion and identifying the management units as UMUs. In some implementations, the processing logic can determine that one or more management units that have been used for wear leveling become unusable, for example, having an error rate or a program/erase cycle count exceeding a predetermined threshold value, and identifies them as UMUs. In some implementations, the processing logic can determine that one or more management units that have been used for wear leveling is not suitable for use in the wear leveling, and identifies them as UMUs.

At operation 220A, the processing logic stores a physical address and a logical address of the identified UMU in a L2P table of UMUs. The L2P table of UMUs refers to a table used to map the logical address (identifiable by a host computing system) to the physical address (identifiable by a memory device) of the UMU, and each entry in the L2P table of UMUs includes the physical address and the logical address of a UMU.

At operation 230A, the processing logic removes, from a physical address space of wear leveling, the physical address of the identified UMU to obtain a modified physical address space of wear leveling. The physical address space of wear leveling includes all physical addresses used for wear leveling, and after the processing logic removes the physical address of the UMU, the processing logic obtains a modified physical address space excluding the UMU.

At operation 240A, the processing logic performs a start-gap wear leveling operation with the modified physical address space. The detail of performing a start-gap wear leveling operation with the modified physical address space will be illustrated with respect to FIG. 2B.

FIG. 2B is a flow diagram of an example method 200B to perform a start-gap wear leveling operation with the modified physical address space, in accordance with some embodiments of the present disclosure. The method 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200B is performed by the wear leveling management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments.

At operation 210B, the processing logic determines that a logical address does not correspond to a UMU in a plurality of management units used for wear leveling. In some implementations, the processing logic can search in a L2P table of UMUs and determines whether any entries of logical addresses matches to the logical address, and responsive to determining that there is no match, determine the logic address does not correspond to a UMU in the management units used for wear leveling.

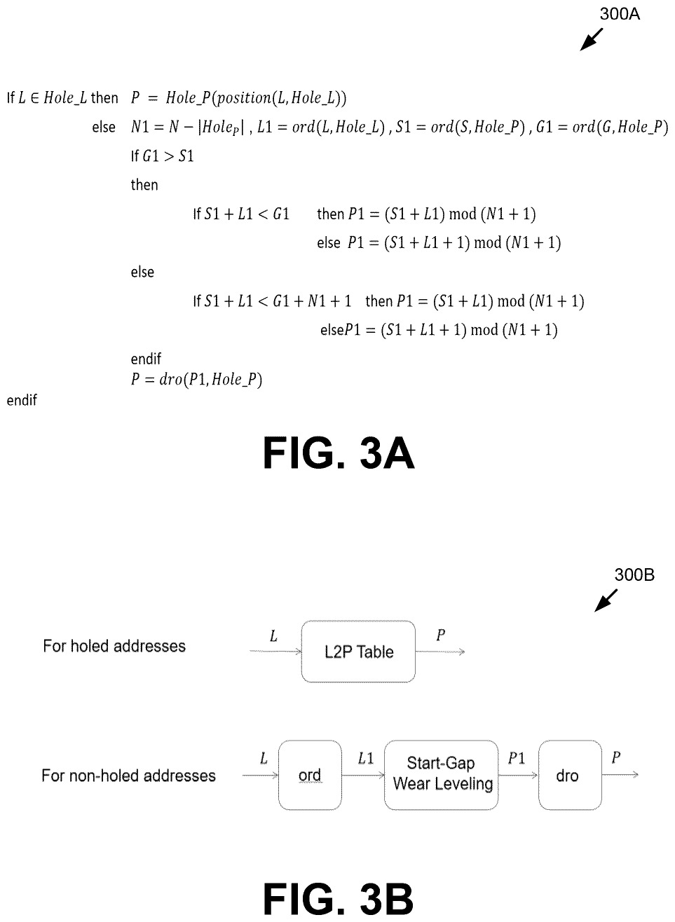

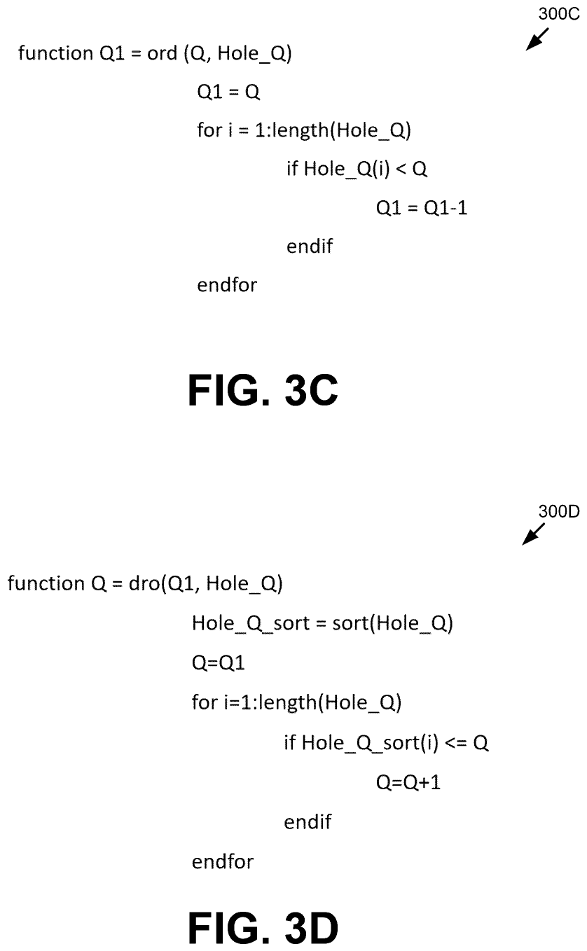

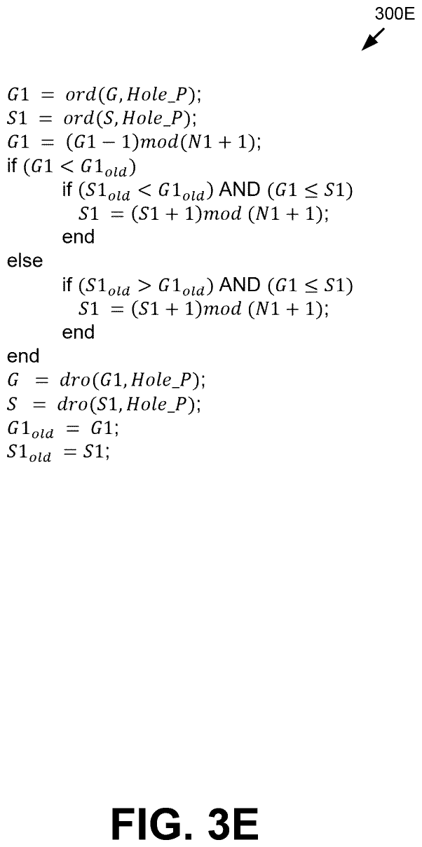

At operation 220B, the processing logic uses a first function to translate the logical address to a modified logical address. An example of the first function will be illustrated with respect to FIG. 3C. In some implementations, the processing logic uses a start-gap wear leveling technique that includes a first register—the gap register and a second register—the start register, and the processing logic uses the first function to translate the first register to a modified first register and translate the second register to a modified second register.

At operation 230B, the processing logic maps the modified logical address to a modified physical address using a modified first register and a modified second register, and the modified first register and the modified second register are used by modifying the values stored in the modified first register in a circular manner and modifying the values stored in the modified second register in a circular manner. Mapping the modified logical address to the modified physical address means that the content stored in the management unit identified by the modified logical address is now moved to the management unit identified by the modified physical address. That is, the data stored in a management unit is moved to a non-UMU neighboring management unit, and the non-UMU management units form a pool used for wear leveling in a circular manner. For example, after the data stored in the first non-UMU management unit in the pool is moved to second non-UMU management unit the for wear leveling operation, for the next movement, the data stored in the last non-UMU management unit in the pool is moved to first non-UMU management unit the for wear leveling operation, and the process continues, i.e., the data stored in the second last non-UMU management unit in the pool is moved to the last non-UMU management unit the for wear leveling operation, until again the data stored in the first non-UMU management unit in the pool is moved to second non-UMU management unit the for wear leveling operation. As such, the data of a management unit is moved to a non-UMU neighboring management unit in a circular manner.

The data movement is facilitated by modifying the values stored in the modified first register in a circular manner and modifying the values stored in the modified second register in a circular manner. In one implementation, the value stored in the modified first register decrements after each data movement, and the value continues decrementing until the value reaches zero and reset to its largest value. The value stored in the modified second register increments upon the number of times of data movement reaches to the number of the useful management units used for wear leveling (i.e., the number of management units excluding UMUs), and the value continues incrementing until the value reaches to its largest value and reset to zero. As such, the processing logic updates the values stored in the modified first register and the modified second register. The updated values stored in the modified first register and modified second register will be used in the next step of wear leveling operation. An example of mapping using a modified first register and a modified second register in a circular manner will be illustrated with respect to FIG. 3A.

At operation 240B, the processing logic uses a second function to translate the modified physical address to a physical address. An example the second function will be illustrated with respect to FIG. 3D.

FIGS. 3A-3E illustrate examples of algorithm and architecture of the modified start-gap wear leveling, in accordance with some embodiments of the present disclosure. L represents the logical address in the address space including UMUs. P represents the physical address in the address space including UMUs. L1 represents the logical address in the address space excluding UMUs, which can be the modified logical address from the original logical address. P represents the physical address in the address space excluding UMUs, which can be the modified physical address from the original physical address. G represents the gap register used in the start-gap wear leveling for the address space including UMUs. S represents the start register used in the start-gap wear leveling for the address space including UMUs. G1 represents the gap register used in the start-gap wear leveling for the address space excluding UMUs. S1 represents the start register used in the start-gap wear leveling for the address space excluding UMUs. N represents the number of the management units used in the start-gap wear leveling for the address space including UMUs. N1 represents the number of the management units used in the start-gap wear leveling for the address space excluding UMUs.

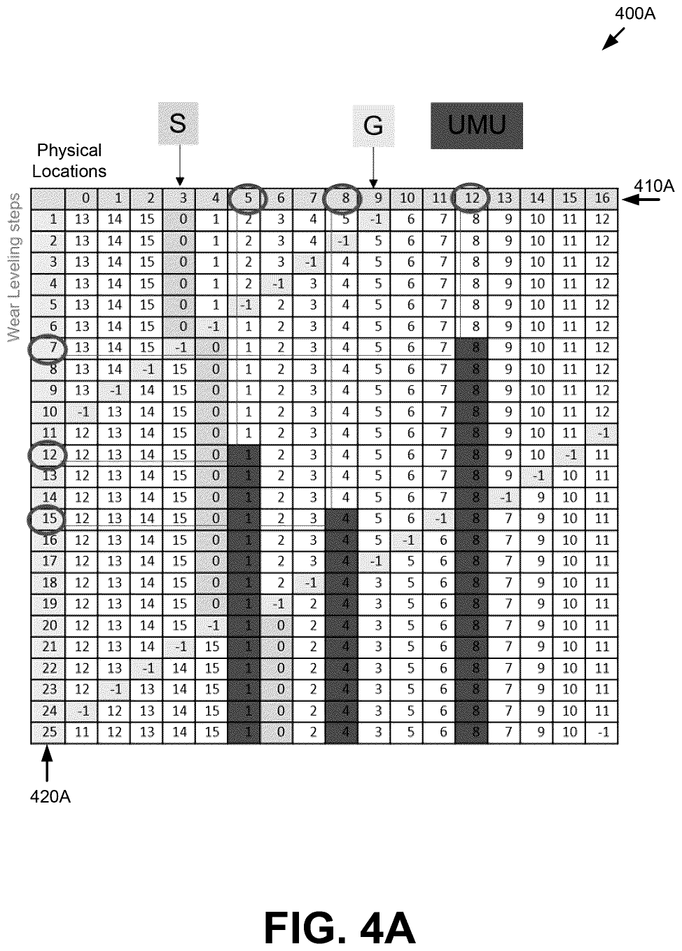

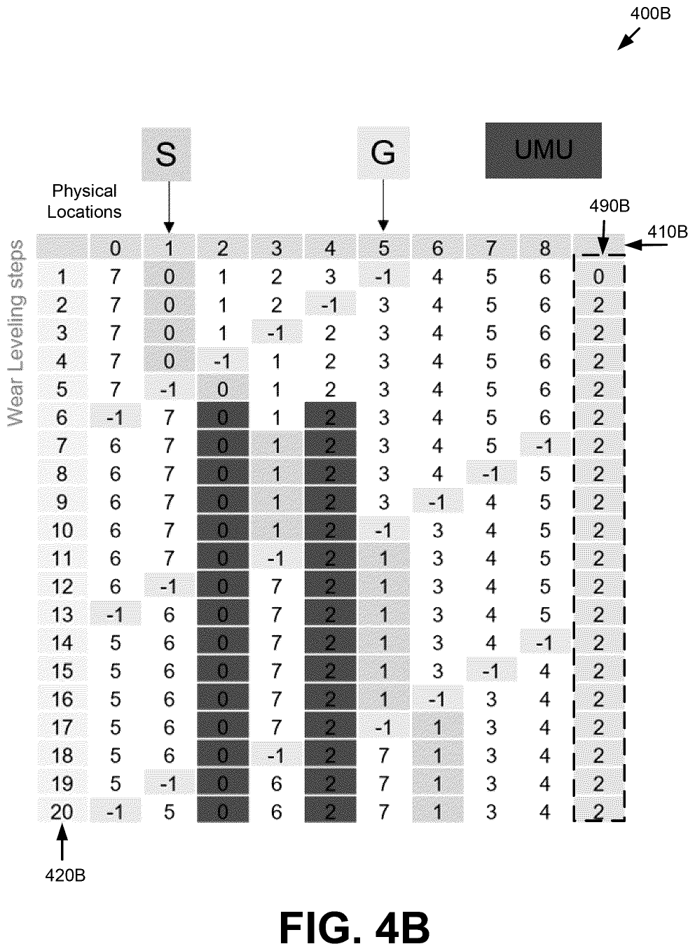

Referring to FIGS. 3A-3B, if a logical address (L) corresponds to a UMU logical address (Hole_L), the memory sub-system controller obtains the physical address (P) as the UMU physical address (Hole_P) by searching in the UMU L2P table based on the UMU logical address (Hole_L). If a logical address (L) does not correspond to a UMU logical address (Hole_L), the memory sub-system controller translates the logical address (L) to the modified logical address (L1) using the first function (ord), maps the modified logical address (L1) to the modified physical address (P1) using the start-gap wear leveling, and translates the modified physical address (P1) to the physical address (P) using the second function (dro). FIG. 3C illustrates an example of the first function (ord) and FIG. 3D illustrates an example of the second function (dro), where the second function is an invert of the first function. FIG. 3E illustrates the circular movement of the gap register and the circular movement of the start register under the modified address space. The detail of performing the modified start-gap wear leveling using these algorithms will be illustrated with respect to FIGS. 4A-4B.

FIGS. 4A-4B illustrate examples of performing the modified start-gap wear leveling, in accordance with some embodiments of the present disclosure. Each graph 400A, 400B illustrates the process and result of performing the modified start-gap wear leveling. Referring to FIG. 4A, the top row 410A represents the physical locations, which can be identified by physical addresses, and includes 17 locations, i.e., location 0 to location 16; the left column 420A represents the steps of the modified start-gap wear leveling, where each step corresponds to one shift of content in the management units and one movement of the Gap register, and includes 25 wear leveling steps. The intersection of the physical locations and the wear leveling steps represents the content stored in the management units, where the content can be referenced by a logical address. Because the association of content with the logical address will not change during the wear leveling, graph 400A uses the logical address to represent the content stored, which can better illustrate the mapping of physical address and logical address provided by the modified start-gap wear leveling.

At wear leveling step 1, the start register (represented by S) begins with pointing to the physical location 3, which corresponds to the logical address 0. The gap register (represented by G) begins with pointing to the physical location 9, and the memory sus-system controller swaps the content stored at physical location 9 (represented by logical address −1) and the content stored at physical location 8 (represented by logical address 5). The logical address −1 may indicate that no useful data is stored corresponding to the logical address. The gap register is then decremented by one physical location. As a result, after wear leveling step 1, the gap register points to the physical location 8, the physical location 8 stores the content represented by logical address −1, and the physical location 9 stores the content represented by logical address 5. At wear leveling step 2, the gap register begins with pointing to the physical location 8, the memory sus-system controller swaps the content stored at physical location 8 (represented by logical address −1) and the content stored at physical location 7 (represented by logical address 4), and the gap register is then decremented by one physical location to point to physical location 7.

The process continues as described above, and at wear leveling step 7, the memory sub-system controller identifies a management unit as a UMU and identifies, by the physical address, the physical location of the UMU, as physical location 12. The sub-system controller can exclude the UMU from the physical locations, i.e., the physical locations now become 16 locations (location 0-11 and 13-16). At wear leveling step 7, the gap register begins with pointing to the physical location 3, the memory sus-system controller swaps the content stored at physical location 3 (represented by “logical address −1”) and the content stored at physical location 2 (represented by “logical address 15”), and the gap register is then decremented by one physical location to point to physical location 2. Also, at wear leveling step 7, the start register increments and moves to pointing to physical location 4 because the content of all management units within the physical locations have been swapped once.

The process continues as described above, and at wear leveling step 10, the gap register begins with pointing to the physical location 0, the memory sus-system controller swaps the content stored at physical location 0 (represented by “logical address −1”) and the content stored at physical location 16 (represented by “logical address 12”), and the gap register is then wrapped up and reset in a circular manner to the other end location of the pool to point to physical location 16.

The process continues as described above, and at wear leveling step 12, the memory sub-system controller identifies a management unit as a UMU and identifies, by the physical address, the physical location of the UMU, as physical location 5. The sub-system controller can exclude the UMU from the physical locations, i.e., the physical locations now become 15 locations (location 0-4, 6-11 and 13-16). At wear leveling step 12, the gap register begins with pointing to the physical location 15, the memory sus-system controller swaps the content stored at physical location 15 (represented by “logical address −1”) and the content stored at physical location 14 (represented by “logical address 10”), and the Gap register is then decremented by one physical location to point to physical location 14.

The process continues as described above, and at wear leveling step 14, the gap register begins with pointing to the physical location 13, the memory sus-system controller swaps the content stored at physical location 13 (represented by “logical address −1”) and the content stored at physical location 11 (represented by “logical address 7”) because the physical location 12 has been excluded, and the gap register is then decremented by one physical location to point to physical location 11.

At wear leveling step 15, the memory sub-system controller identifies a management unit as a UMU and identifies, by the physical address, the physical location of the UMU, as physical location 8. The sub-system controller can exclude the UMU from the physical locations, i.e., the physical locations now become 14 locations (location 0-4, 6-7, 9-11 and 13-16). At wear leveling step 12, the gap register begins with pointing to the physical location, the memory sus-system controller swaps the content stored at physical location 15 (represented by “logical address −1”) and the content stored at physical location 14 (represented by “logical address 10”), and the gap register is then decremented by one physical location to point to physical location 14.

The process continues as described above, and at wear leveling step 17, the gap register begins with pointing to the physical location 9, the memory sus-system controller swaps the content stored at physical location 9 (represented by “logical address −1”) and the content stored at physical location 7 (represented by “logical address 3”) because the physical location 8 has been excluded, and the gap register is then decremented by one physical location to point to physical location 7.

The process continues as described above, and at wear leveling step 19, the gap register begins with pointing to the physical location 6, the memory sus-system controller swaps the content stored at physical location 6 (represented by “logical address −1”) and the content stored at physical location 4 (represented by “logical address 0”) because the physical location 5 has been excluded, and the gap register is then decremented by one physical location to point to physical location 4. At wear leveling step 20, the start register increments and moves to pointing to physical location 6 because the content of all management units within the physical locations have been swapped once and the physical location 5 has been excluded. The process continues to wear leveling step 25 as described above as shown in FIG. 4A.

Referring to FIG. 4B, the top row 410B represents the physical locations, which can be identified by physical addresses, and includes 9 locations, i.e., location 0 to location 8; the left column 420B represents the steps of the modified start-gap wear leveling, where each step corresponds to one shift of content in the management units and one movement of the gap register, and includes 20 wear leveling steps. The intersection of the physical locations and the wear leveling steps represents the content stored in the management units, where the content can be referenced by a logical address. Because the association of content with the logical address will not change during the wear leveling, graph 400B uses the logical address to represent the content stored, which can better illustrate the mapping of physical address and logical address provided by the modified start-gap wear leveling.

At wear leveling step 1, the start register (represented by S) begins with pointing to the physical location 1, which corresponds to the logical address 0. The gap register (represented by G) begins with pointing to the physical location 5, and the memory sus-system controller swaps the content stored at physical location 5 (represented by logical address −1) and the content stored at physical location 4 (represented by logical address 3). The logical address −1 may indicate that no useful data is stored corresponding to the logical address. The gap register is then decremented by one physical location. As the result, after wear leveling step 1, the gap register points to the physical location 4, the physical location 4 stores the content represented by logical address −1, and the physical location 5 stores the content represented by logical address 3. At wear leveling step 2, the gap register begins with pointing to the physical location 4, the memory sus-system controller swaps the content stored at physical location 4 (represented by logical address −1) and the content stored at physical location 3 (represented by logical address 2), and the gap register is then decremented by one physical location to point to physical location 3.

The process continues as described above, and at wear leveling step 4, the gap register begins with pointing to the physical location 0, the memory sub-system controller swaps the content stored at physical location 2 (represented by “logical address −1”) and the content stored at physical location 1 (represented by “logical address 0”), and the gap register is then rotated by one physical location to point to physical location 1. The start register is also changed to point to the physical location 2.

The process continues as described above, and at wear leveling step 6, the memory sub-system controller identifies two management units as UMUs and identifies, by the physical addresses, the physical locations of the UMUs, as physical locations 2 and 4. The sub-system controller can exclude the UMU from the physical locations, i.e., the physical locations now become 7 locations (location 0-1, 3, and 5-8). At wear leveling step 6, the gap register begins with pointing to the physical location 0, the memory sus-system controller swaps the content stored at physical location 0 (represented by “logical address −1”) and the content stored at physical location 8 (represented by “logical address 6”), and the gap register is then wrapped up and reset in a circular manner to point to physical location 8. Also, at wear leveling step 6, the start register is still pointing to the physical location 2. Then, at wear leveling step 7, the start register increments and moves to pointing to physical location 3 because the physical location 2 has been excluded.

The process continues as described above, and at wear leveling step 10, the gap register begins with pointing to the physical location 5, the memory sus-system controller swaps the content stored at physical location 5 (represented by “logical address −1”) and the content stored at physical location 3 (represented by “logical address 1”) because the physical location 4 has been excluded, and the gap register is then decremented by two physical locations to point to physical location 3.

At wear leveling step 11, the gap register begins with pointing to the physical location 3, the memory sus-system controller swaps the content stored at physical location 3 (represented by “logical address −1”) and the content stored at physical location 1 (represented by “logical address 7”) because the physical location 2 has been excluded, and the gap register is then decremented by two physical locations to point to physical location 1. Also, at wear leveling step 11, the start register increments and moves to pointing to physical location 5 because the content of all management units within the physical locations have been swapped once and the physical location 4 has been excluded. The process continues to wear leveling step 20 as described above as shown in FIG. 4A.

As shown in FIG. 4B, the right column 490B indicates the number of locations where the content changes at each step of the wear leveling. As such, the number at wear leveling step 1 is zero because no content change in the step 1, and the number at wear leveling step thereafter is two because only two locations where the content change. The number in the right column 490B servers to check whether each wear leveling step is performed correctly.

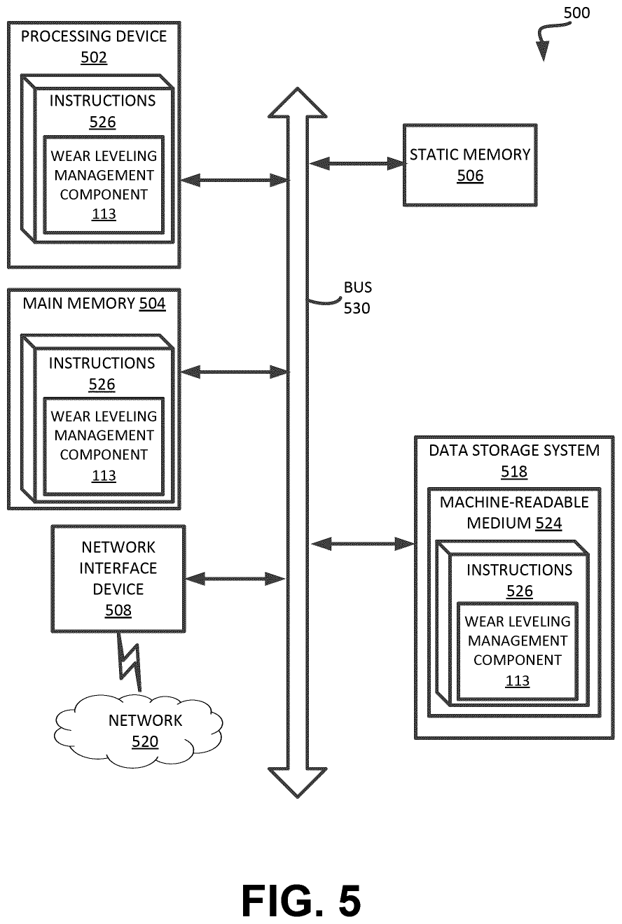

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the wear leveling management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a media management component (e.g., the wear leveling management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device coupled to the memory device, the processing device to perform operations comprising:
identifying at least one unusable management unit (UMU) in a plurality of management units that are designated for wear leveling;
storing, in a data structure, a physical address and a logical address of the identified at least one UMU;
excluding, from a physical address space for wear leveling, the physical address of the identified at least one UMU; and
performing a wear leveling operation using the physical address space, wherein the wear leveling operation moves data of a management unit to a neighboring management unit in a circular manner.

2. The system of claim 1, wherein identifying the at least one UMU further comprises determining that a value of an endurance metric measured at least one of the plurality of management units satisfies a threshold criterion.

3. The system of claim 1, wherein the data structure comprises a plurality of records, and wherein each record of the plurality of records maps a physical address to a logical address of a UMU.

4. The system of claim 1, wherein performing the wear leveling operation using the physical address space further comprises:
translating a target logical address to a modified logical address using a first function;
mapping the modified logical address to a modified physical address; and
translating the modified physical address to a target physical address using a second function.

5. The system of claim 4, wherein performing the wear leveling operation using the physical address space further comprises:
determining that the target logical address does not correspond to a logical address of a UMU in the data structure.

6. The system of claim 4, wherein mapping the modified logical address to the modified physical address further comprises:
copying content stored in a management unit corresponding to the modified logical address to a management unit corresponding to the modified physical address.

7. The system of claim 4, wherein performing the wear leveling operation using the physical address space further comprises:
using a value stored in a modified first register referencing an adjacent management unit corresponding to the modified logical address; and
responsive to mapping the modified logical address to the modified physical address, decrementing the modified first register in a circular manner.

8. The system of claim 4, wherein performing the wear leveling operation using the physical address space further comprises:
using a value stored in a modified second register; and
responsive to mapping a plurality of modified logical addresses to a plurality of modified physical address in the modified physical address space, incrementing the modified second register in a circular manner.

9. The system of claim 4, wherein performing the wear leveling operation using the modified physical address space is responsive to a number of write operations performed in the memory device satisfying a threshold value.

10. The system of claim 4, wherein the second function is an inverse function of the first function.

11. A method comprising:
identifying, by a processing device, at least one unusable management unit (UMU) in a plurality of management units that are designated for wear leveling;
storing, in a data structure, a physical address and a logical address of the identified at least one UMU;
excluding, from a physical address space for wear leveling, the physical address of the identified at least one UMU; and
performing a wear leveling operation using the physical address space, wherein the wear leveling operation moves data of a management unit to a neighboring management unit in a circular manner.

12. The method of claim 11, wherein identifying the at least one UMU further comprises determining that a value of an endurance metric measured at least one of the plurality of management units satisfies a threshold criterion.

13. The method of claim 11, wherein the data structure comprises a plurality of records, and wherein each record of the plurality of records maps a physical address to a logical address of a UMU.

14. The method of claim 11, wherein performing the wear leveling operation using the physical address space further comprises:
translating a target logical address to a modified logical address using a first function;
mapping the modified logical address to a modified physical address; and
translating the modified physical address to a target physical address using a second function.

15. The method of claim 14, wherein performing the wear leveling operation using the physical address space further comprises:
determining that the target logical address does not correspond to a logical address of a UMU in the data structure.

16. The method of claim 14, wherein mapping the modified logical address to the modified physical address further comprises:
copying content stored in a management unit corresponding to the modified logical address to a management unit corresponding to the modified physical address.

17. A non-transitory computer-readable storage medium comprising instructions that, when executed by a processing device, cause the processing device to perform operations comprising:
identifying at least one unusable management unit (UMU) in a plurality of management units that are designated for wear leveling;
storing, in a data structure, a physical address and a logical address of the identified at least one UMU;
excluding, from a physical address space for wear leveling, the physical address of the identified at least one UMU; and
performing a wear leveling operation using the physical address space wherein the wear leveling operation moves data of a management unit to a neighboring management unit in a circular manner.

18. The non-transitory computer-readable storage medium of claim 17, wherein identifying the at least one UMU further comprises determining that a value of an endurance metric measured at least one of the plurality of management units satisfies a threshold criterion.

19. The non-transitory computer-readable storage medium of claim 17, wherein the data structure comprises a plurality of records, and wherein each record of the plurality of records maps a physical address to a logical address of a UMU.

20. The non-transitory computer-readable storage medium of claim 17, wherein performing the wear leveling operation using the physical address space further comprises:
translating a target logical address to a modified logical address using a first function;
mapping the modified logical address to a modified physical address; and
translating the modified physical address to a target physical address using a second function.
